(19) United States
(12) Patent Application Publication
(10) Pub. No.: US 2023/0031795 A1
(43) Pub. Date: Feb. 2, 2023

(54) Fluid pump and temperature management system comprising the fluid pump, and motor vehicle comprising the fluid pump and/or the temperature management system

(71) Applicant: NIDEC GPM GmbH, Auengrund OT Merbelsrod (DE)

(72) Inventor: Franz PAWELLEK, Lautertal (DE)

(21) Appl. No.: 17/812,053

(22) Filed: Jul. 12, 2022

(30) Foreign Application Priority Data
Jul. 28, 2021 (DE) 102021119578.0

(51) Int. Cl. F04C 15/00; F04C 2/44; F04C 11/00; B60K 11/02

(52) U.S. Cl. CPC F04C 15/0065; F04C 2/44; F04C 11/001; B60K 11/02; F04C 2240/40; F04C 2240/803

(57) ABSTRACT

A fluid pump, in particular for a temperature management system, of an electric battery-driven motor vehicle or of a hybrid motor vehicle, having at least one first pump assembly configured and provided for pumping a first fluid medium; and at least one second pump assembly configured and provided for pumping a second fluid medium; wherein the first pump assembly and the second pump assembly are provided as orbiter eccentric piston pumps, particularly as two-row orbiter eccentric piston pumps with respectively phase-shifted orbiter eccentric pistons and are coupled with a single drive motor in a drivable manner.

### FIELD OF THE INVENTION

The invention relates to a fluid pump according to the preamble of claim 1, and a temperature management system comprising the fluid pump, and a motor vehicle comprising the fluid pump or the temperature management system.

### BACKGROUND OF THE INVENTION

In modem vehicles, the importance of temperature management systems is increasing. A noticeable trend is the integration of electric coolant pumps in cooling modules. Typically, at least two electric pumps are used. In particular, it has proven useful to use a low-temperature pump to circulate a low-temperature cooling fluid for cooling e.g. vehicle batteries. Typical temperatures of such low-temperature cooling fluids are m a range below 40° C.

Furthermore, it has been proven to use a high-temperature coolant pump, wherein the high-temperature coolant fluid circulated therewith is used for cooling inverters and/or drives of electric battery-driven motor vehicles or of hybrid motor vehicles.

In order to produce such a dual-circuit coolant arrangement, st is typical to use in each case a separate pump for each coolant circuit, i.e. for the low-temperature circuit and for the high-temperature circuit. Each of these pumps has a pump assembly and a drive motor as well as optionally a control device. Such an arrangement causes relatively high assembly and cabling outlay, since in particular each of the pumps must be connected separately by means of at least one plug connection to a load circuit and/or to a data bus.

Furthermore, the use of two individual pumps requires increased expenditure with regard to the respective cooling circuit sealing. In addition, such a cooling module arrangement requires a relatively large amount of installation space.

Centrifugal pumps are typically used as pump assemblies, but their degree of efficiency is not always satisfactory. Furthermore, a vacuum pump with an orbiter eccentric piston design is known from DE 10 2006 016 791 A1. Such a vacuum pump with an orbital eccentric piston design has a drive shaft with an eccentric bearing pin, on which an orbital eccentric piston functioning as a rotary piston is rotatably mouthed. Such an orbiter eccentric piston is dimensioned with respect to its diameter such that an outer circumferential surface of the orbiter eccentric piston in a cylindrical pump chamber with a cylindrical pump chamber inner wail, contacting or almost contacting the latter, forms a very small sealing slot. The pump chamber is connected to a fluid inlet and a fluid outlet. A pendulum plate is arranged as a stop valve between the fluid inlet and the fluid outlet, said pendulum plate being arranged in a pump housing between the pump inlet and the pump outlet so as o be pivotable about an axis in parallel with the drive axis. The stop valve has a blocking portion which protrudes into the pump chamber and is mounted with a free end in a radially extending guide slot of the orbiter eccentric piston. This makes it possible to fluidically separate the pump chamber between the fluid inlet and fluid outlet in a reliable manner by means of the stop valve, irrespective of the current position of the orbiter eccentric piston.

Together with the stop valve and a narrowly dimensioned sealing gap between the orbiter eccentric piston and the pump chamber wall, two partial volumes are thus produced in each case during one revolution of the orbiter eccentric piston within the pump chamber, wherein one of the partial volumes communicates with the fluid inlet and the other partial volume communicates with the fluid outlet. A revolution of the orbiter eccentric piston initially enlarges the partial volume allocated to the fluid inlet, so that there is an intake of the fluid to he pumped. The second partial volume is increasingly reduced during the course of one revolution of the orbiter eccentric piston within the pump chamber, so that the fluid contained therein is discharged through the fluid outlet.

A fluid pump with this design is known and used as a vacuum pump for gaseous media. A characteristic of a vacuum pump with an orbiter eccentric piston design is the relatively high pulsation by reason of the design, since only one pumping procedure takes place per revolution of the orbiter eccentric piston, resulting in a pumping characteristic which makes such a vacuum pump rather unsuitable for liquid fluids by reason of its incompressibility and possibly undesirable pressure peaks resulting therefrom.

### SUMMARY OF THE INVENTION

Therefore, it is the object of the invention to provide a fluid pump which allows a simple and cost-effective design of a temperature management system. Furthermore, the fluid pump is to cause a small amount of electrical connection outlay and a small amount of hydraulic/fluid sealing outlay.

The fluid pump is to permit an increase in the degree of efficiency compared to conventional coolant pumps. Furthermore, a fluid pump in accordance with the invention is intended to provide the possibility of effective cooling of a control device for a drive motor of the fluid pump.

Furthermore, a temperature management system is to be provided which can be produced with less assembly and sealing outlay compared to the prior art. Furthermore, costs for the provision of such a temperature management system are to be optimised. In particular, it should be possible to minimise the number of electrical connectors. Moreover, improved temperature control of the control device is to be possible.

With regard to a motor vehicle, the object of the invention is to provide a motor vehicle which has optimised energy consumption for a temperature management system, e.g, for temperature control of a battery and/or an inverter and drive.

These objects are achieved with respect to the fluid pump comprising a fluid pump having the features of claim 1. With respect to the temperature management system, the above-mentioned objects are achieved with a temperature management system having the features of claim 13. With respect to the motor vehicle, the above-mentioned objects are achieved with a motor vehicle having the features of claim 14.

A fluid pump in accordance with the invention is particularly suitable for a temperature management system e.g. of an electric battery-driven motor vehicle or a hybrid motor vehicle and comprises:
at least one first pump unit configured and provided for pumping a first fluid medium;
at least one second pump unit configured and provided for pumping a second fluid medium.

In accordance with the invention, such a fluid pump of the type in question is developed by virtue of the fact that the first pump unit and the second pump unit are provided as orbiter eccentric piston pumps, particularly as two-row orbiter eccentric piston pumps with respectively phase-shifted arbiter eccentric pistons and are coupled with a single drive motor in a drivable manner.

With such a fluid pump in accordance with the invention, a high level of functional integration of the pump drives of two different coolant circuits is achieved. Furthermore, the pump units of the respective pump circuits are driven by one and the same drive motor, thus giving rise to a reduced electrical connection outlay.

The preferred selection of a two-row orbiter eccentric piston pump as the pump unit allows the advantages specific to orbiter eccentric piston pumps, namely in particular their increased degree of efficiency, to be utilised in the pumping of liquid fluids to increase the overall degree of efficiency of the fluid pump module whilst at the same time maintaining relatively low-frequency pulsation.

The use of a two-row orbiter eccentric piston pump for in each case one fluid pump module also reduces the pulsation in amplitude compared to the use of a one-row orbiter eccentric piston pump, in particular when orbiter eccentric pistons of the orbiter eccentric piston pumps of a pump unit can be driven in a manner phase-shifted with respect to one another, in particular phase-shifted by 180° if there are two orbiter eccentric piston pumps per pump unit.

In a preferred embodiment, the single drive motor is controllably coupled by means of a single control unit. This reduces both the number of drive motors required and the number of corresponding control units compared to the prior art and makes assembly simpler. Moreover, costs of such a fluid pump are reduced.

In order to achieve a particularly simple connection of fluid-carrying inlet and outlet lines, all fluid connection interlaces of the pump units are advantageously arranged in a common flange plane. This ensures that the mounting direction does not have to be changed in order to attach any inlet or outlet lines. This represents a simplification.

Furthermore, it can be advantageous that fluid inlets of s two-row pump unit and/or fluid outlets of a two-row pump unit are respectively fluidly connected. With such a fluidic connection, the pulsation at a common fluid inlet and/or at a common fluid outlet can be flattened at least with regard to its amplitude.

It can also be advantageous that one of the two pump units is used for pumping a low-temperature cooling medium and the other one of the two pump units is used for pumping the high-temperature cooling medium, wherein a temperature management system for an e.g. electric battery-driven motor vehicle can thereby be produced in a simple manner.

Furthermore, it is naturally also possible to pump cooling media of different types, e.g. coolants of different chemical compositions, in addition to cooling media of different temperatures.

Furthermore, it can be advantageous that both orbiter eccentric piston pumps are set axially successively against one another and are fluidly separated by means of a partition wall, wherein it is particularly advantageous that the partition wall has a lower heat conductivity compared to that of the material of the respective pump housing of the orbiter eccentric piston pump units. This makes it possible to thermally separate the two cooling circuits from one another in an improved manner, since only a small amount of heat exchange can take place between the cooling circuits via the partition wall.

Furthermore, h can be advantageous that the control device (ECU) is set/mounted against a free side, particularly a tree end face of the orbiter eccentric piston pump for the low-temperature cooling medium. This provides a relatively large contact surface between the control device and the low-temperature orbiter eccentric piston pump, Furthermore, optimum cooling for the control device is achieved, since the low-temperature cooling medium which is circulated in the adjacent orbiter eccentric piston pump can provide cooling of the control device ECU in a simple manner.

It is also expedient that the drive motor is set/mounted against a free side, particularly a free end face of the orbiter eccentric piston pump for tie high-temperature cooling medium.

With this measure, the drive motor which is rather insensitive to higher temperatures compared to a control device can be adroitly connected to the fluid pump in an expedient manner. At the same time, a part of the drive motor, e.g. a bearing shield of the drive motor, takes over the function of closing the pump chamber of the orbiter eccentric piston pump, thus achieving functional integration.

Furthermore, it can be advantageous that the drive motor, as seen in an axial direction, is arranged between two orbiter eccentric piston pump units and the drive motor itself thus acts as a partition wall. On the one hand, this can avoid the need for a separate component to produce a partition wall between two orbiter eccentric piston pump units. Furthermore, by interposing the drive motor between two orbiter eccentric piston pumps, the thermal decoupling between the orbiter eccentric piston pump units can be improved.

Furthermore, it can be advantageous that single eccentric shafts of the orbiter eccentric piston pump units arc coupled by means of its clutch in a manner capable of transmitting torque. The provision of single eccentric shafts which each drive one orbiter eccentric piston pump unit, and the coupling of the single eccentric shafts when setting orbiter eccentric piston pumps against one another simplifies the production and assembly of the drive shafts compared to e.g. a continuous one-piece drive shaft configured for a plurality of orbiter eccentric piston pump units.

A particularly advantageous arrangement is provided f the control device (ECU) reaches through by means of a bus carrier of at least one of the pump housings arranged between the control device and the drive motor, in particular reaches through to the drive motor and is connected thereto. In the installed state, the bus carrier is thus protected from mechanical effects within the pump housing. Separate measures to protect and/or fasten the bus carrier are not required.

The fluid pimp in accordance with the invention renders it possible in a simple manner that the entire fluid pump has only one single electric plug connection which can be advantageously arranged in the area of the control device. Therefore, it is easily possible to reduce the electrical cabling outlay when mounting such a fluid pump in a temperature management system.

With regard to a temperature management system, the above-mentioned objects are achieved by a temperature management system in that at least one of the fluid pumps described above is present. In an expedient manner, such temperature management systems can be used for electric battery-driven motor vehicles or a hybrid motor vehicle.

With respect to a motor vehicle, the invention relates to a motor vehicle comprising a fluid pump in accordance with the invention or a temperature management system in accordance with the invention.

### BRIEF DESCRIPTION OF THE FIGURES

The invention will be described hereinafter with the aid of the drawing. In the drawing:

FIG. 1A: show a cross-section through a pump unit of a fluid pump in accordance with the invention with an arbiter eccentric piston design with an orbiter eccentric piston in a top dead centre position;

FIG. 1B: show the cross-section shown in FIG. 1A with the orbiter eccentric piston in a bottom dead centre position;

FIG. 1C: shows the fluid pump in accordance with the invention in a longitudinal section.

FIG. 2: shows a plan view of a connection flange of a fluid pump in accordance with the invention.

### DETAILED DESCRIPTION OF THE INVENTION

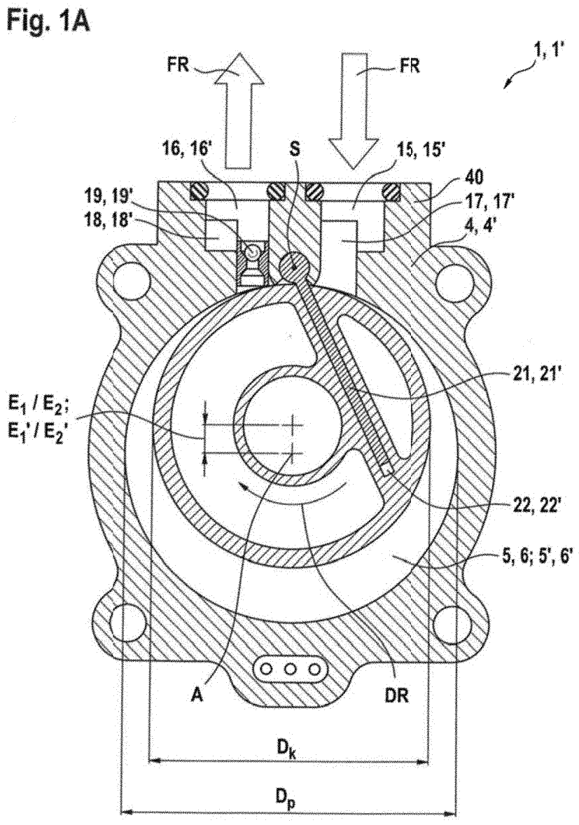

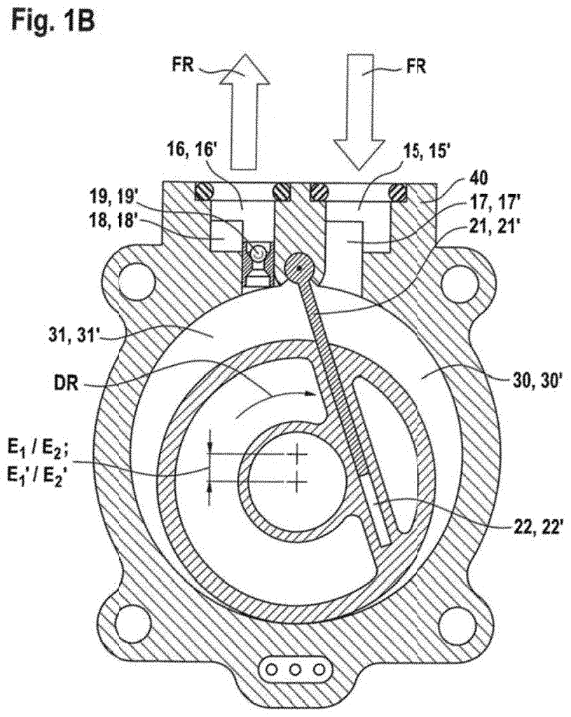

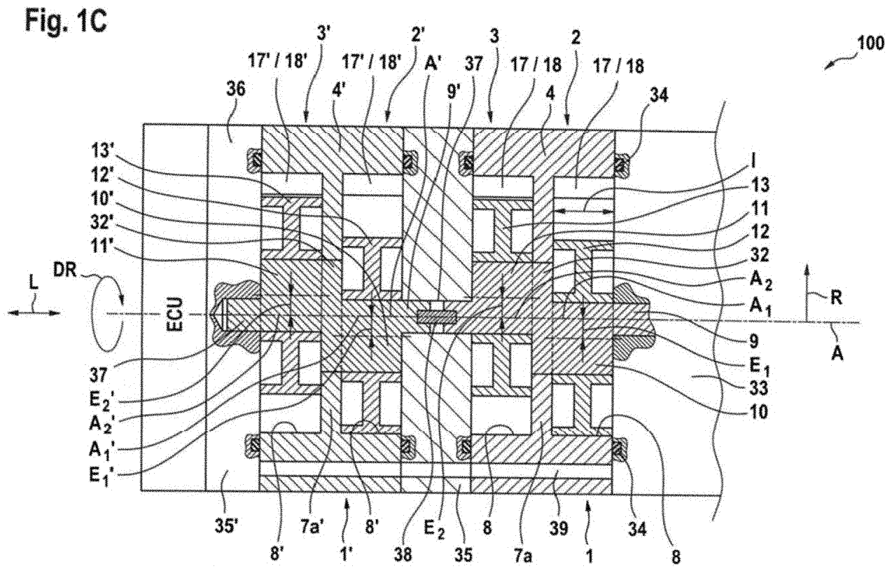

The basic structure of a fluid pump 100 in accordance with the invention is described hereinafter with reference to FIGS. 1A, 1B and 1C, said fluid pump comprising, as pump assemblies 1, 1′, first orbiter eccentric piston pump and a second orbiter eccentric piston pump. The embodiment described has orbiter eccentric piston pumps in a so-called two-row design, in which each orbiter eccentric piston pump—as described hereinafter—is designed as a pump assembly 1, 1′ with at least two pump units 2, 3/2′, 3′ which comprise arbiter eccentric pistons 12, 13/12′, 13′ which are phase-shifted with respect to one another.

The pump device 1, 1′ has a first pump unit 2, 2′ and a second pump unit 3, 3′ which are arranged in a common pump housing 4, 4′. A first pump chamber 5, 5′ associated with the first pump unit 2, 2′ and a second pump chamber 6, 6′ associated with the second pump unit 3, 3′ are arranged in the common pump housing 4, 4′. The first pump chamber 5, 5′ and the second pump chamber 6, 6′ are separated from one another in a longitudinal direction L by means of a partition wall 7a, 7a′. The pump chambers 5, 6/5′, 6∝ are designed as cylindrical recesses in the pump housing 4, 4′ and each comprise a cylindrical pump chamber wall 8, 8′. As seen in the longitudinal direction L, the first pump chamber 5, 5′ and the second pump chamber 6, 6′ comprise a longitudinal extension 1 which, in the exemplified embodiment shown according to FIG. 1C, is the same for both pump chambers 5, 6/5′, 6/5′, 6′.

An eccentric shaft 9, 9′ is arranged centrally in a radial direction R with respect to the pump chambers 5, 6/5′, 6′ such that it can be rotated about a drive axis A and rotatably driven. In the exemplified embodiment shown, the eccentric shaft 9, 9′ is designed as a common eccentric shaft 9, 9′ for the first pump unit 2, 2′ and the second pump unit 3, 3′. The eccentric shaft 9, 9′ carries a first eccentric 10 10′ and a second eccentric 11, 11′ wherein the first eccentric 10, 10′ is allocated to the first pump chamber 5, 5′ and the second eccentric 11, 11′ is allocated to the second pump chamber 6, 6′.

A first orbiter eccentric piston 12, 12′ is arranged on the first eccentric 10, 10′ so as to be rotatably mounted relative to the first eccentric 10, 10′, said first orbiter eccentric piston being arranged in the first pump chamber 5, 5′ offset by an eccentricity E₁, E₁′ with respect to the drive axis A. A second orbiter eccentric piston 13, 13′ is mounted on the second eccentric 11, 11′ so as to be rotatable relative to the second eccentric 11, 11′, said second orbiter eccentric piston being arranged within the second pump chamber 6, 6′ offset by an eccentricity E₂, E₂′ of the second eccentric 11, 11′ with respect to the common drive axis A. The eccentricities E₁, E₂/E₁′, E₂′ are phase-shifted with respect to one another by an angular offset Δφ in a direction of rotation DR about the drive axis A. In the exemplified embodiment, the phase shift Δφ amounts to 180°.

An axial longitudinal extension of the orbiter eccentric pistons 12, 13/12′, 13′ corresponds to the longitudinal extension 1 of the respective pump chambers 5, 6/5′, 6′ so that, as seen in the longitudinal direction L, the two orbiter eccentric pistons 12, 13/12′, 13′ each have the same axial longitudinal extension as the respectively associated pump chambers 5, 6/5′, 6′. A diameter Dₖ of the orbiter eccentric pistons 12, 13/12′, 13′ is dimensioned in each ease such that it is in each ease smaller by twice the associated eccentricity E₁/E₁′ or E₂/E₂′ compared to a diameter Dₚ of the associated pump chamber (cf. FIG. 1A).

Each pump chamber 5, 6/5′, 6′ is allocated in each ease a fluid inlet 15, 15′ and a fluid outlet 16, 16′ which penetrate the pump housing 4, 4′ and are fluidly connected to the respective pump chambers 5, 6/5′, 6′. Such a fluidic connection between the fluid inlet 15, 15′ and the corresponding pump chambers 5, 6/5′, 6′ is achieved by means of an inlet connection channel 17, 17′ which communicates with both pump chambers 5, 6/5′, 6′ and the fluid inlet 15, 15′. In a similar manner, the fluid outlet 16, 16′ is connected to both pump chambers 5, 6/5′, 6′ by means of an outlet connection channel 18 which issues into both pump chambers 5, 6/5′, 6′.

Between the outlet connection channel 18, 18′ and the inlet connection channel 17, 17′, generally speaking between an outlet of a specific pump chamber and an inlet of the same pump chamber, for each pump chamber 5, 6/5′, 6′ in an intermediate region between the outlet connection channel 18, 18′ and the inlet connection channel 17, 17′ in the pump housing 4, 4′ a stop valve 20, 20′ is arranged in such a manner as to be able to pivot about a pivot axis S. The stop valve 20, 20′ protrudes with its plate-like blocking portion 21, 21′ into the respective pump chamber 5, 6/5′, 6′ as far as a guide slot 22, 22′ of the orbiter eccentric piston 12, 13/12′, 13′, wherein the blocking portion 21, 21′ is mounted displaceably in the guide slot 22, 22′, in particular displaceably with a narrow clearance.

In the outlet connection channel 18, 18′, a non-return valve 19, 19′ can be expediently arranged, which is configured and designed so as to prevent an overflow of fluid to be pumped from the first pump chamber 5 into the second pump chamber 6, 6′ or vice versa.

The following special features are implemented in the illustrated exemplified embodiment according to FIGS. 1A, 1B and 1C:
The eccentricities E1, E1′ and E2, E2′, i.e. the distance in terms of amount between a longitudinal axis of the first eccentric 10, 10′ and the drive axis A and the eccentricity E₂, E₂′, i.e. the distance in terms of amount of a longitudinal axis of the second eccentric 11, 11′ to the drive axis A are equal in terms of amount. Of course, in other embodiments it is also possible where appropriate to configure the eccentricities E1, E1′ and E2, E2′ to be unequal in terms of amount, if, where appropriate, this appears to be expedient as a result of other structural boundary conditions.
The eccentricities E1, E1′ and E2, E′ are phase-shifted by 180° in the embodiment according to FIGS. 1A, 1B and 1C. This means that the first eccentric 10 follows or precedes the second eccentric 11, 11′ by 180° in the direction of rotation DR. Of course, it is also possible if required to select a phase shift Δφ to a value other than 180° if this is desired by reason of a particularly desired pump characteristic.
The drive axis A is a common drive axis A for both eccentrics 10, 11/10′, 11′ which are arranged axially successively in the longitudinal direction L in the pump housing 4, 4′. Of course, it is also possible to arrange the first eccentric 10, 10′ and the second eccentric 11, 11′, i.e. as a result the first pump unit 2 and the second pump unit 3, 3′, not successively in the longitudinal direction L, bus instead next to one another e.g. in the direction of view n the longitudinal direction L, such that two individual eccentric shafts 9, 9′ are provided tor driving the first eccentric 10, 10′ and the second eccentric 11, 11′. Such a design of he pump assembly in accordance with the invention can possibly also be expedient if e.g. a particularly short axial installation length is desired, but more installation space is available radially with respect to the drive axes A₁ and/or A₂. A central drive having a single drive motor is possible for this purpose if e.g. the drive axes A₁, A₂ are coupled to one another and to the drive motor 33 without slippage by means of a gear unit, such as a pinion gear or chain gear, so that a phase shift Δφ between these eccentric shafts 9, 9′ is maintained during operation.

Each of the arbiter eccentric pistons 12, 13/12′, 13′ is designed with regard to its diameter Dₖ in such a way that the first and the orbiter eccentric piston 12, 13/12′, 13′ each form a circumferential sliding contact or a narrow sealing gap with the associated first pump chamber wall 7, 7′ or second pump chamber wall 8, 8′ when the eccentric shaft 9, 9′ is driven in the direction of rotation DR.

As a result, during a revolution of one of the orbiter eccentric pistons 12, 13/12′, 13′ in the respective pump chamber 5, 6/5′, 6′, a first partial volume 30, 30′ (cf. FIG. 1B) is defined in interaction with the stop valve 20, 20′, said partial volume communicating with the fluid inlet 15, 15′. In addition, a second partial volume 31, 31′ (cf. FIG. 1B) is defined which communicates with the fluid outlet 16, 16′ of the respective pump chamber 5, 6/5′, 6′.

The partial volumes 30, 31 are not illustrated in FIG. 1A because in FIG. 1A the arbiter eccentric piston 12, 13/12′, 13′ is in a top dead centre position. The partial volumes are not formed in this position. In every other position of the orbiter eccentric piston 12, 13/12′, 13′, the First partial volume 30, 30′ is spanned between the stop valve 20, 20′ and the region of the orbiter eccentric piston 12, 13/12′, 13′ which is arranged closest to the pump chamber wall 8, 8′. Starting from the position of the orbiter eccentric piston 12, 13 illustrated in FIG. 1A, the first partial volume 30, 30′ increases whilst at tic same time the second partial volume 31, 31′ decreases if the orbiter eccentric piston 12, 13/12′, 13′ is displaced from its top dead centre position by a clockwise rotation of the drive shaft. As a result, the fluid located in the second partial volume 31, 31′ is displaced towards rite fluid outlet 16, 16′.

The partial volumes 30, 31/30′, 31′ on both sides of the stop valve 20, 20′ change with the circumferential sliding contact or sealing gap between the orbiter eccentric piston 12,13/12′, 13′ and the pump chamber wall 7, 7′ or 8, 8′, such that a cyclic intake and displacement procedure takes place within one revolution of the eccentric shaft 9, 9′ in each of the pump chambers 5, 6/5′, 6′.

Due to the phase shift Δφ of the two orbiter eccentric pistons 12, 13/12′, 13′ with respect to one another, a total of two displacement procedures per revolution thus take place at the fluid outlet 16, 16′, which connects both pump chambers 5, 6/5′, 6′ by means of the outlet connection channel 18, 18′ via one revolution of the eccentric shaft 9, 9′. Corresponding to this, two intake procedures or supply procedures take place at the fluid inlet 15, 15′ accordingly per revolution of the eccentric shaft 9, 9′. This is illustrated in the drawing by a fluid flow direction FR.

The eccentric shaft 9, 9′ has a support bearing 32, 32′ in the region of the partition wall 7a, 7a′. An open end face of the first pump chamber 5, 5′ is covered e.g. by means of a bearing shield of a drive motor 33. The drive motor 33 is connected to or comprises the eccentric shaft 9, 9′. A seal 34, e.g. an O-ring seal, is expediently located between the drive motor 33 and the pump housing 4, 4′.

In the case of the fluid pump 100 in accordance with the invention as shown in FIG. 1C, the drive motor 33, the pump unit the pump unit and the control unit ECU are combined to form the fluid pump 100 substantially in axial succession along the drive axis A.

A partition wall component 35 is arranged between the pump unit 1 and the pump unit 1′.The partition wall component 35 can comprise the bearing point 37, in which the ends of the eccentric shafts 9, 9′ are mounted. The eccentric shaft 9, 9′ are coupled e.g. with a clutch 38 in a manner capable of transmitting torque.

A partition wall component 35′ is arranged between the pump unit 1′ and the control unit ECU. The partition wall component 35′ can expediently be a base plate 36 of the control unit ECU. The base plate 36 an serve as a carrier of e.g. electronic components of the control unit ECU which, by virtue of this measure, can be cooled particularly effectively by fluid circulated in the pump unit 1′.

On the side of the drive motor 33, it can be expedient that a bearing shield (not shown in FIG. 1C) of the drive motor 33 covers the first pump chamber 5 towards the pump assembly 1, whereby high functional integration takes place.

In the case of the fluid pump 100 in accordance with be invention e.g. the pump device is allocated to a high-temperature coolant circuit, in which a high-temperature cooling medium is circulated. Furthermore, e.g. the pump device 1′ is allocated to a low-temperature coolant circuit, in which low-temperature cooling which has a lower temperature than the high-temperature cooling medium is circulated. Typical operating temperatures for a high-temperature cooling circuit are e.g. temperatures of the high-temperature cooling medium of ca. 120° C. A low-temperature cooling medium in a low-temperature cooling circuit has e.g. a temperature of ca. 40° C.

In such a case of application, it is particularly recommended to form the partition wall component 35, which is arranged between the pump assemblies 1, 1′, from a material which has a lower thermal conductivity than the material of the pump housings 4, 4′ in order thus to achieve improved thermal separation of the cooling circuits.

In the embodiment according to FIG. 1C, the pump unit which circulates the low temperature cooling advantageously arranged adjacent to the control unit ECU. Therefore, in a particularly advantageous manner, in particular if the partition wall component 35′ is formed as a base plate 36, the control turn ECU can be cooled particularly effectively with cooling medium of relatively low temperature. In the prescribed case of application of the partition wall component 35′ as base plate 36 for the control unit ECU, it is recommended to use a material which has a particularly low thermal conductivity in order to optimise the heat transfer from the control unit ECU to the low-temperature cooling circuit and thus the cooling of the control unit ECU. The control unit ECU is electrically connected to the drive motor 33 by means of a bus carrier 39 which reaches though the pump housings 4, 4′ and the partition wall component 35.

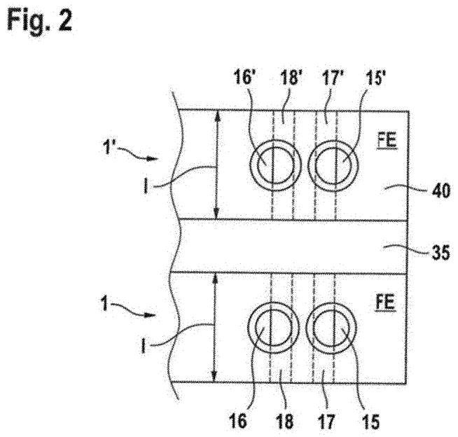

FIG. 2 shows a plan view of a connection region 40 of the pump housings 4, 4′, wherein the course of the inlet connection channels 17, 17′ and its relative allocation to the fluid inlets 15, 15′ is shown in dashed lines. In the example shown, the inlet connection channels 17, 17′ extend in the longitudinal direction L over the entire extension of the associated pump housings 4, 4′.

Similar to the inlet connection channels 17, 17′, the connection channels 18, 18′ are also illustrated by dashed lines. The outlet connection channels 18, 18′ are allocated to the fluid outlets 16, 16′. In the exemplified embodiment shown in FIG. 2, the outlet connection channels 18, 18′ extend over the entire longitudinal extension of the associated pump housings 4, 4′.

Through such an arrangement of the inlet and outlet connecting channels 17, 17′, 18, 18′, respectively, two outlets of the pump chambers 5, 6/5′, 6′ and two inlets of the pump chambers 5, 6/5′, 6′ are each fluidly connected to one another, so that a total volume flow of both pump chambers 5, 6/5′, 6′ is present at the fluid outlet 16, 16′ and at the fluid inlet 15, 15′ respectively.

During operation of a fluid pump 100 comprising puma assemblies 1, 1′ which are described in greater detail above and have a liquid pump medium, e.g. a coolant or an oil, a high degree of inner efficiency could be determined which, for a specified volume flow rate, mainly results from the fact that a relatively low drive rotational speed is required for the eccentric shafts 9, 9′ and relatively low friction occurs in the interior of the pump assembly 1, 1′.

With a fluid pump 100 comprising such pump assemblies 1, 1′, together with the drive motor 33 and the control unit ECU, a fluid pump 100 in accordance with the invention having a high degree of efficiency for achieving the objects in accordance with the invention can be realised in a simple manner.

Such a fluid pump 100 is particularly suitable for pumping liquid fluid and can be used in particular in cooling systems of motor vehicles, in particular in cooling systems for electric battery-driven vehicles and/or hybrid vehicles which have e.g. temperature management systems.

### LIST OF REFERENCE SIGNS

1, 1′ fluid pump module

2, 2′ first pump unit, first orbiter eccentric piston pump

3, 3′ second pump unit, second orbiter eccentric piston pump

4,4′ pump housing

5, 5′ first pump chamber

6, 6′ second pump chamber

7a, 7a′ partition wall

7, 7′ first pump chamber wall

8, 8′ second pump chamber wall

9, 9′ eccentric shaft

10, 10′ first eccentric

11, 11′ second eccentric

12, 12′ first orbiter eccentric piston

13, 13′ second orbiter eccentric piston

15, 15′ fluid inlet

16, 16′ fluid outlet

17, 17′ inlet connection channel

18, 18′ outlet connection channel

19, 19′ Non-return valve

20, 20′ stop valve

21, 21′ blocking portion

22, 22′ guide slot

30, 30′ first partial volume

31, 31′ second partial volume

32 support bearing

33 drive motor

34 seal

35 partition wall component

36 base plate

37 bearing point

38 clutch

39 bus earner

40 connection region

100 fluid pump

A, A₁, A₂, Aₙ drive axis

Dₖ, Dₚ diameter

DR direction of rotation

E₁, E₂, Eₙ/E₁′, E₂′, Eₙ′ eccentricity

ECU control unit

FR fluid flow direction

L Longitudinal direction

l longitudinal extension

R radial axis

S pivot axis

Δφ phase shift

I claim:

1. A fluid pump, useful for a temperature management system of an electric battery-driven or hybrid motor vehicle, comprising:
at least one first pump assembly configured and provided for pumping a first fluid medium; and
at least one second pump assembly configured and provided for pumping a second fluid medium, wherein
the first pump assembly and the second pump assembly are provided as orbiter eccentric piston pumps, particularly as two-row orbiter eccentric piston pumps with respectively phase-shifted orbiter eccentric pistons and are coupled with a single drive motor in a drivable manner.

2. The fluid pump according to claim 1, wherein the drive motor is controllably coupled by means of a control unit.

3. The fluid pump according to claim 1, wherein all fluid connection interfaces of the pump assemblies are arranged in a common flange plane.

4. The fluid pump according to claim 1, wherein fluid inlets of a number of the two-row pump assemblies and/or fluid outlets of a number of the two-row pump assemblies are respectively fluidly connected.

5. The fluid pump according to claim 1, wherein one of the two pump assemblies is configured and provided for pumping a low-temperature cooling medium and the other one of the two pump assemblies is configured and provided for pumping a high-temperature cooling medium with a higher temperature than that of the low-temperature cooling medium.

6. The fluid pump according to claim 1, wherein both pump assemblies are set axially successively against one another and are fluidly separated by means of a partition wall element having a lower heat conductivity compared to that of the material of the pump housing.

7. The fluid pump according to claim 1, wherein the control unit is set/mounted against a free side, particularly a live end face of the orbiter eccentric piston pump for the low-temperature cooling medium.

8. The fluid pump according to claim 1, wherein the drive motor is set or mounted against a free side, particularly a free end face of the orbiter eccentric piston pump for the high-temperature cooling medium.

9. The fluid pump according to claim 1, wherein the drive motor, as seen in an axial direction, is arranged between two orbiter eccentric piston pumps and acts as a partition wall element.

10. The fluid pump according to claim 1, wherein single eccentric shafts of the orbiter eccentric piston pumps are coupled by means of a clutch in a manner capable of transmitting torque.

11. The fluid pump according to claim 1, wherein the control unit reaches through by means of a bus carrier of at least one of the pump housings arranged between the control unit and the drive motor.

12. The fluid pump according to claim 1, wherein the fluid pump has only one electric plug connection, particularly in the area of the control unit, particularly of a control device housing.

13. A temperature management system for an electric battery-driven motor vehicle or a hybrid vehicle, comprising a fluid pump the fluid pump of claim 1.

14. A motor vehicle comprising a fluid pump according to claim 1.

15. A motor vehicle comprising a temperature management system according to claim 13.
